(19) United States
(12) Patent Application Publication
(10) Pub. No.: US 2007/0097402 A1
(43) Pub. Date: May 3, 2007

(54) METHOD FOR PRINTING AN IMAGE DURING AN IMAGE PLAYING MODE

(76) Inventor: Jung-Lieh Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/306,255

(22) Filed: Dec. 21, 2005

(30) Foreign Application Priority Data
Oct. 28, 2005 (TW) 094137841

(51) Int. Cl. G06F 3/12

(52) U.S. Cl. 358/1.13

(57) ABSTRACT

Under a playing mode of an image playing program and through a combination of key presses, an image that is currently on the screen can be outputted as a printed image to a printer without leaving the playing mode of the image playing program. The playing action of the playing mode of the image playing program is paused after the combination of key presses and a print dialog appearing on the screen can be used for adjusting the printed image. The method can quickly output a played image under a playing mode of the image playing program.

### BACKGROUND OF THE INVENTION

1. Field of the Invention

The present invention relates to a method for printing an image, and more specifically, to a method for printing an image during an image playing mode.

2. Description of the Prior Art

Generally a program for playing images (such as a screensaver or a slide show program) is incapable of printing the played image at the same time when the program operates in an image playing mode. The prior art shows that the program must leave the image playing mode first, then select an image among the images from an image database related to the image playing program for printing, and lastly launch a print function commonly included in the image playing program to output the requested image. It is pretty complicated to print a requested image with the prior art method. The playing mode must be interrupted and dropped temporarily by the image playing program when it comes to printing a played image, resulting in a total restart of the image playing mode if needed when printing is complete.

### SUMMARY OF THE INVENTION

Therefore, the primary objective of the claimed invention is to provide a method for printing an image during an image playing mode to solve the above problem.

The claimed invention provides a method for printing an image during an image playing mode. The method comprises opening an image playing mode of an image playing program, launching a printing function without leaving the image playing mode when detecting a combination of key presses, and outputting a print image to a printing device according to an image that is currently on a screen of a computer when detecting the combination of key presses.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart of a method for printing an image during an image playing mode of the present invention.

FIG. 2 is an illustration of a screen showing a print dialog box during an image playing mode when detecting a combination of key presses.

### DETAILED DESCRIPTION

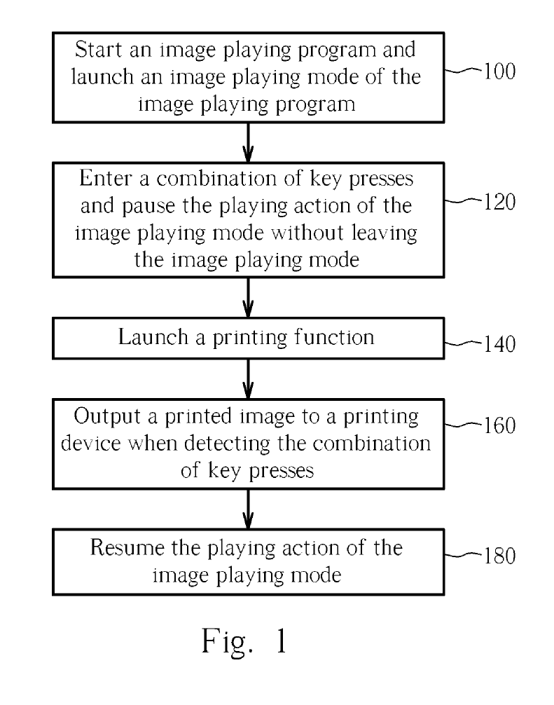

Please refer to FIG. 1, which is a flow chart of a method for printing an image during an image playing mode of the present invention. The method comprises the following steps:

Step 100: Start an image playing program and launch an image playing mode of the image playing program;

Step 120: Enter a combination of key presses and pause the playing action of the image playing mode without leaving the image playing mode;

Step 140: Launch a printing function;

Step 160: Output a printed image to a printing device according to an image that is currently on a screen of a computer when detecting the combination of key presses; and

Step 180: Resume the playing action of the image playing mode.

The image playing program can be a screensaver or a slide show program. The image playing program will select images from an image database and display the selected images on the screen of the computer. The selected images are generally displayed on the screen in a full-screen mode. In addition, the plurality of selected images (or slides) are displayed on the screen by a predetermined sequence or a sequence set by a user, each image being displayed on the screen one after another within a predetermined time interval or as controlled by the user.

In Step 120, when a predetermined combination of key presses is detected in the method of the present invention, the image playing program then pauses the image playing mode but does not leave the image playing mode. The predetermined combination of key presses can be an one button press or a combination or a plurality of key presses.

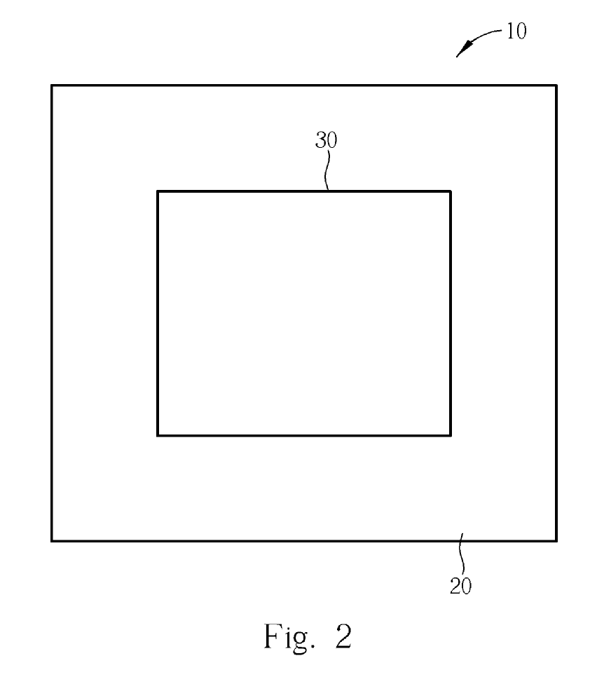

Please refer to FIG. 2, which is an illustration of a screen showing a print dialog box during an image playing mode when detecting a combination of key presses. The desktop 10 is filled with a full-screen played image 20 during the playing mode of the image playing program. When the predetermined combination of key presses is pressed as in Step 120, a print dialog box 30 appears above the played image 20. Meanwhile, the image playing program pauses the playing of the played image 20, which is thus made to stay on the screen. As a printed image (not shown in FIG. 2) is outputted from the static played image 20 as described in Step 160, the image playing program selects from the image database the played image 20 that is currently on the screen of the computer. The action of outputting the printed image comprises previewing the printed image with the print dialog box 30.

The present invention can further allow editing of the played image 20 in the print dialog box 30 before the printed image is outputted to a printing device. For example, editing can be to apply a design template to the played image 20 and output the played image 20 with the design template as a printed image, to set up the layout of the played image 20 and output it as a printed image, or to adjust the brightness, contrast, sharpness, scale, or printing direction of the played image 20 to enrich the printed image. Additionally, the printing dialog box 30 can be used for selecting different printing devices to output the printed image since sometimes more than one printer is connected to the computer.

The image playing program resumes the image playing mode once performing all the related settings in the printing dialog box 30 and outputting the printed image to the selected printing device are finished, as in Step 180. The image playing program resumes the playing action of the image playing mode.

With a combination of key presses, the present invention can pause an image playing mode of an image playing program without leaving the image playing mode; and with a printing dialog box appearing on a screen, the played image that is currently on the screen of a computer when the combination of key presses takes place can be outputted to a printing device. Further image editing is also allowable in the printing dialog box before the image is outputted to the printing device. The method can quickly output a played image under a playing mode of the image playing program and effectively solve the inconvenience of the prior art image outputting method.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for printing an image during an image playing mode comprising:
launching an image playing mode of an image playing program;
launching a printing function without leaving the image playing mode when detecting a combination of key presses; and
outputting a printed image to a printing device according to an image that is currently on a screen of a computer when detecting the combination of key presses.

2. The method of claim 1 wherein launching an image playing mode of an image playing program comprises launching an image playing mode of a screensaver.

3. The method of claim 1 wherein launching an image playing mode of an image playing program comprises launching an image playing mode of a slide show.

4. The method of claim 1 further comprising pausing the playing action of the image playing mode without leaving the image playing mode when detecting the combination of key presses.

5. The method of claim 4 wherein pausing the playing action of the image playing mode comprises pausing the playing action of the image playing mode until completing output of the printed image to the printing device according to the image that is currently on the screen of the computer.

6. The method of claim 1 further comprising selecting from an image database the image that is currently on the screen of the computer when detecting the combination of key presses.

7. The method of claim 1 wherein outputting the printed image to the printing device according to the image that is currently on the screen of the computer comprises previewing the printed image on the screen.

8. The method of claim 1 wherein outputting the printed image to the printing device according to the image that is currently on the screen of the computer comprises selecting a printing device from a plurality of printing devices for outputting the printed image.

9. The method of claim 1 further comprising editing the image that is currently on the screen of the computer.

10. The method of claim 9 wherein editing the image that is currently on the screen of the computer comprises applying a design template to the image.

11. The method of claim 9 wherein editing the image that is currently on the screen of the computer comprises setting up the layout of the image.

12. The method of claim 9 wherein editing the image that is currently on the screen of the computer comprises adjusting the brightness, contrast, sharpness, scale, or printing direction of the image.
